(19) United States
(12) Patent Application Publication
(10) Pub. No.: US 2009/0304477 A1
(43) Pub. Date: Dec. 10, 2009

(54) CONNECTING MEMBER

(75) Inventor: BIN DAI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/254,142

(22) Filed: Oct. 20, 2008

(30) Foreign Application Priority Data
Jun. 4, 2008 (CN) 200810301980.3

(51) Int. Cl. F16B 37/04

(52) U.S. Cl. 411/180

(57) ABSTRACT

An exemplary connecting member includes a head portion, a body portion, and a connecting neck portion connecting the head portion to the body portion. The head portion, the connecting neck portion, and the body portion cooperatively define a collar depression. An outer surface of the connecting neck portion connects with an outer surface of the head portion. The outer surface of the connecting neck portion and the outer surface of the head portion cooperatively define a smooth curved surface at a boundary of the outer surface of the connecting neck portion and the outer surface of the head portion.

### BACKGROUND

1. Technical Field

The present disclosure relates to a connecting member.

2. Description of the Related Art

A means to connect two parts together generally includes, for example, welding, nut locking, and rivet locking the two parts together.

Generally, a connecting member, such as a nut or a rivet includes a head portion, a body portion, and a connecting neck portion connecting the head portion to the body portion. The head portion, the body portion, and the connecting neck portion cooperatively define a circular depression between the head portion and the body portion. An outer surface of connecting neck portion and an outer surface of the head portion define a sharp corner, as a result, the connecting member is a T shape configuration.

When the connecting member is used to connect two parts, the two parts exert a drawing force on the connecting member. As a result, the head portion is easily broken off the body portion at the sharp corner resulting in damage to the connecting member.

Therefore, a new connecting member is desired in order to overcome the above-described shortcomings.

### SUMMARY

A connecting member includes a head portion, a body portion, and a connecting neck portion connecting the head portion to the body portion. The head portion, the connecting neck portion, and the body portion cooperatively define a collar depression. An outer surface of the connecting neck portion connects with an outer surface of the head portion. The outer surface of the connecting neck portion and the outer surface of the head portion cooperatively define a smooth curved surface at a boundary of the outer surface of the connecting neck portion and the outer surface of the head portion.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present connecting member. Moreover, in the drawings, like reference numerals designate corresponding parts throughout several views, and all the views are schematic.

FIG. 1 is an isometric view of a connecting member in accordance with a first embodiment of the present disclosure.

FIG. 2 is a side cross-sectional, isometric view of the connecting member in FIG. 1.

FIG. 3 is a side cross-sectional view of the connecting member before embedded into a part.

FIG. 4 is a side cross-sectional view of the connecting member after embedded in the part shown in FIG. 3.

FIG. 5 is an isometric view of a connecting member in accordance with a second embodiment of the present disclosure.

FIG. 6 is a side cross-sectional view of a connecting member in accordance with a third embodiment of the present disclosure.

### DETAILED DESCRIPTION

Reference will now be made to the drawings to describe embodiments of the present connecting member in detail.

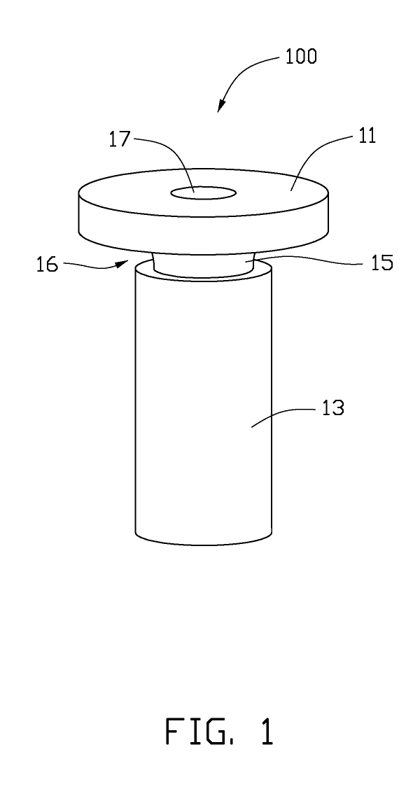

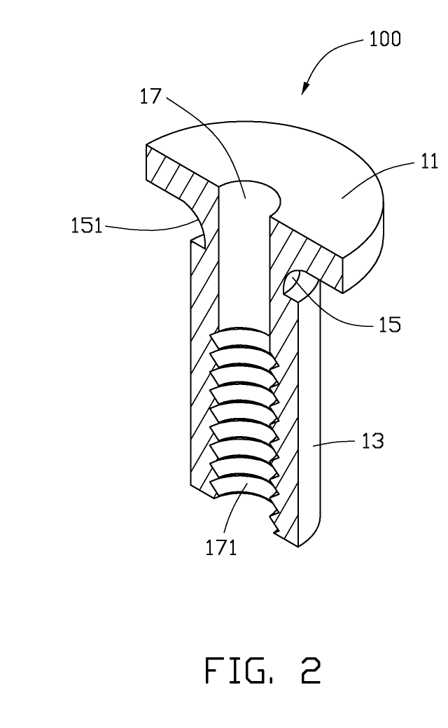

Referring to FIGS. 1 and 2, in a first embodiment of the present disclosure, a connecting member 100 is shown. The connecting member 100 is a rivet, and includes a head portion 11, a body portion 13, and a connecting neck portion 15 connecting the head portion 11 to the body portion 13. The head portion 11, the body portion 13, and the connecting neck portion 15 cooperatively define a collar depression 16. An outer surface of the connecting neck portion 15 and an outer surface of the head portion 11 cooperatively define a smooth curved surface 151 at a boundary of the outer surface of the connecting neck portion 15 and the outer surface of the head portion 11.

In the illustrated embodiment, the head portion 11 and the body portion 13 both have a cylindrical shape. The connecting member 100 is hollow and defines a through hole 17. A plurality of threads 171 are defined in an inner surface of the through hole 17 to engage with threads of other member such as a nut.

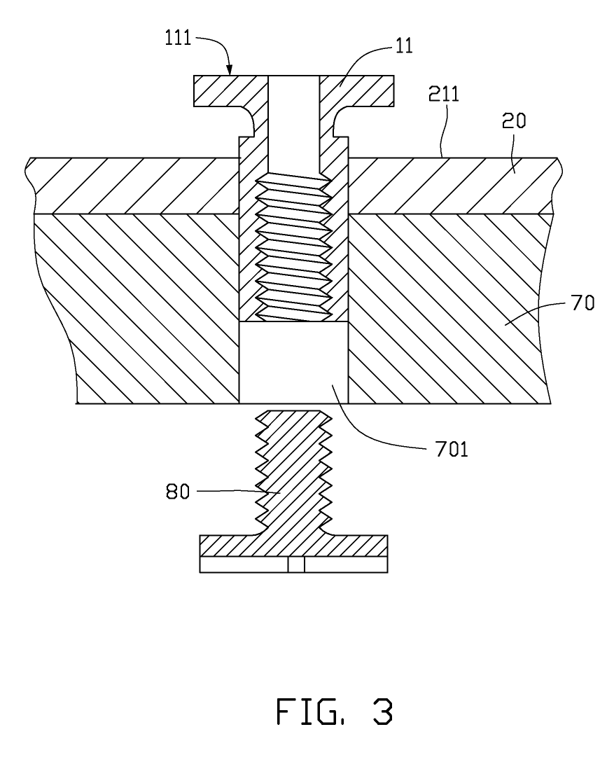

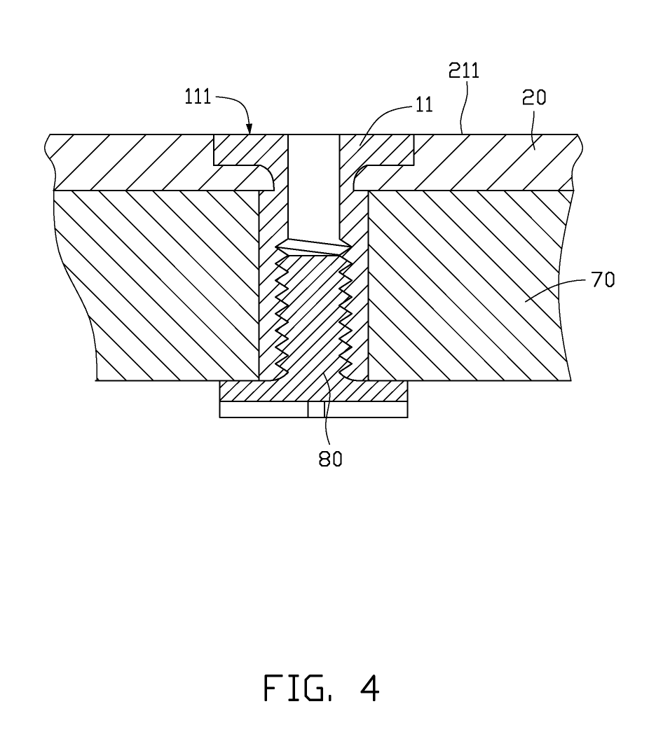

Referring to FIGS. 3 and 4, in use, the body portion 13 is inserted through a hole 201 of a first part 20 and a hole 701 of a second part 70 in that order, the head portion 11 resists a top surface 211 of the first part 20.

Then the head portion 11 is pressed by an external force such that the head portion 11 is embedded into the first part 20 such that a top surface 111 of the connecting member 100 is coplanar with the top surface 211 of the first part 20. Finally, a nut 80 is inserted into the through hole 17 in such manner that threads of the nut 80 engages with threads 171 of the connecting member 100.

When connecting member 100 is being embedded into the first part 20, the first part 20 deforms under pressure from the connecting member 100. Material of a portion of the first part 20 easily displaces into the smooth curved surface 151 of the depression 16 and the depression 16 is filled with displaced material. Thereby, a connect strength among the first part 20, the second part 70, and the connecting member 100 is enhanced.

After the second part 70 is fixed on the first part 20 by the connecting member 100, the first part 20 and the second part 70 exert a drawing force along a longitudinal direction of the connecting member 100 to the connecting member 100. The smooth curved surface 151 reduces a stress concentration at a boundary of the head portion 11 and the connecting neck portion 15, thereby preventing the head portion 11 detaching from the connecting neck portion 15 and enhancing a mechanical strength of the connecting member 100.

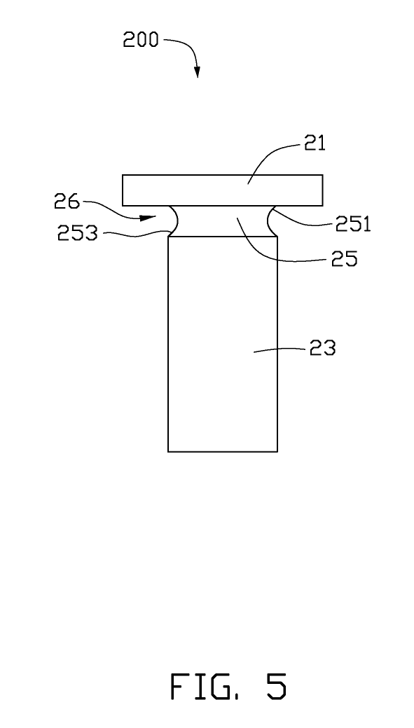

Referring to FIG. 5, a connecting member 200 in accordance with a second embodiment of the present disclosure is shown. The connecting member 200 is similar to the connecting member 100. The connecting member 200 includes a head portion 21, a body portion 23, and a connecting neck portion 25 connecting the head portion 21 to the body portion 23. The head portion 21, the body portion 23, and the connecting neck portion 25 cooperatively define a collar depression 26. An outer surface of the connecting neck portion 25 and an outer surface of the head portion 21 cooperatively define a smooth curved surface 251 at a boundary of the outer surface of the connecting neck portion 25 and the outer surface of the head portion 21. An outer surface of the connecting neck portion 25 and an outer surface of the body portion 23 cooperatively define a smooth curved surface 253 at a boundary of the outer surface of the connecting neck portion 25 and the outer surface of the body portion 23.

The smooth curved surface 253 further reduces a stress concentration, and enhances a mechanical strength of the connecting member 100.

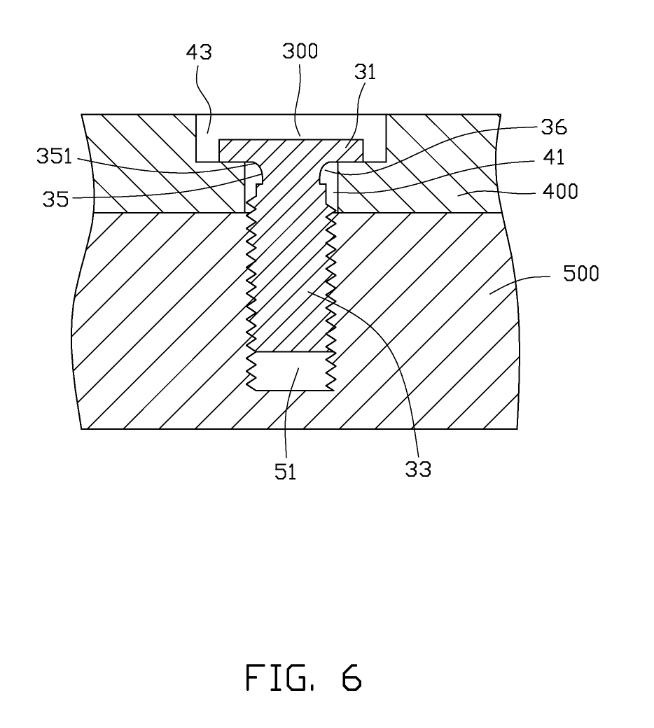

Referring to FIG. 6, a connecting member 300 in accordance with a third embodiment is shown. In the illustrated embodiment, the connecting member 300 is a nut. The connecting member 300 includes a head portion 31, a body portion 33, and a connecting neck portion 35 connecting the head portion 31 to the body portion 33. The head portion 31, the body portion 33, and the connecting neck portion 35 cooperatively define a collar depression 36. In addition, an outer surface of the connecting neck portion 35 and an outer surface of the head portion 31 cooperatively define a smooth curved surface 351 at a boundary of the outer surface of the connecting neck portion 35 and the outer surface of the head portion 31. In the illustrated embodiment, the connecting member 300 is a flat head nut, and the body portion 33 is substantially cylindrical.

In use, the body portion 33 is passed through a through hole 41 of a first part 400 and engages in the threaded hole 51 of a second part 500, the head portion 31 is located in a counterbore 43 of the first part 400, then the first part 400 is fixed on the second part 500. The smooth curved surface 351 reduces a stress concentration, and enhances a mechanical strength of the connecting member 300.

It can be understood that, the connecting member 300 can be other nut.

Finally, while the embodiments have been described and illustrated, the disclosure is not to be construed as being limited thereto. Various modifications can be made to the embodiments by those of ordinary skill in the art without departing from the true spirit and scope of the disclosure as defined by the appended claims.

What is claimed is:

1. A connecting member comprising:
a head portion, a body portion, and a connecting neck portion connecting the head portion to the body portion, wherein the head portion, the connecting neck portion, and the body portion cooperatively defines a collar depression, an outer surface of the connecting neck portion connects with an outer surface of the head portion, the outer surface of the connecting neck portion and the outer surface of the head portion cooperatively define a smooth curved surface at a boundary of the outer surface of the connecting neck portion and the outer surface of the head portion.

2. The connecting member as claimed in claim 1, wherein the depression is shaped substantially as a collar.

3. The connecting member as claimed in claim 1, wherein an outer surface of the connecting neck portion and an outer surface of the body portion cooperatively define a smooth curved surface at a boundary of the outer surface of the connecting neck portion and the outer surface of the body portion.

4. The connecting member as claimed in claim 1, wherein the connecting member is a rivet.

5. The connecting member as claimed in claim 4, wherein the rivet defines a through hole, and a plurality of threads are defined in an inner surface of the through hole.

6. The connecting member as claimed in claim 1, wherein the connecting member is a nut.

7. The connecting member as claimed in claim 6, wherein the nut is a flat head nut.
